(19) United States
(12) Patent Application Publication
(10) Pub. No.: US 2017/0063980 A1
(43) Pub. Date: Mar. 2, 2017

(54) METHOD AND DEVICE FOR ACCESSING SERVER

(71) Applicant: Xiaomi Inc., Beijing (CN)

(72) Inventors: Hong Chen, Beijing (CN); Yanlu Zhang, Beijing (CN); Enxing Hou, Beijing (CN)

(21) Appl. No.: 15/141,805

(22) Filed: Apr. 28, 2016

(30) Foreign Application Priority Data
Aug. 31, 2015 (CN) 201510549907.8

(51) Int. Cl. H04L 29/08; G06F 9/445; H04L 12/28

(52) U.S. Cl. CPC H04L 67/1025; H04L 12/2807; H04L 12/2834; H04L 67/18; G06F 8/61

(57) ABSTRACT

A method and a device for accessing a server are provided. The method includes: obtaining a first access indicator for indicating a geographic region to which a default access server belongs, when it is detected an intelligent device is accessing a network. The method further includes determining the default access server according to the geographic region indicated by the first access indicator and accessing the default access server by the intelligent device.

### CROSS-REFERENCE TO RELATED APPLICATIONS

This application is based on and claims priority to Chinese Patent Application No. 201510549907.8, filed on Aug. 31, 2015, the entire contents of which are incorporated herein by reference.

### FIELD

The present disclosure relates to the smart home field, and more particularly, to a method and a device for accessing a server.

### BACKGROUND

Many intelligent devices in the smart home may be controlled and managed by a server. Correspondingly, they need to access a network-side server when these intelligent devices access a network.

In the related art, manufacturers may write an address of a default access server of the intelligent device to a chip of a communication module of the intelligent device when assembling the intelligent device. The intelligent device may access the server directly according to the address of the server embedded in the chip of the communication module when accessing the network.

### SUMMARY

Embodiments of the present disclosure provide a method and a device for accessing a server. The technical solution is provided as follows.

According to a first aspect of embodiments of the present disclosure, there is provided a method for assessing a server by an intelligent device. The method includes: obtaining a first access indicator for indicating a geographic region to which a default access server belongs when it is detected that the intelligent device is accessing a network; determining the default access server according to the geographic region indicated by the first access indicator; and accessing the default access server by the intelligent device.

According to a second aspect of embodiments of the present disclosure, there is provided a device for assessing a server. The device includes: a processor, and a memory configured to store an instruction executable by the processor. The processor is configured to: obtain a first access indicator for indicating a geographic region to which a default access server belongs, when it is detected that an intelligent device is accessing a network; determine the default access server according to the geographic region indicated by the first access indicator; and access the default access server by the intelligent device.

According to a third aspect of embodiments of the present disclosure, there is provided a non-transitory computer-readable storage medium having stored therein instructions that, when executed by a processor of a device, causes the device to perform the method for accessing a server. The method includes: obtaining a first access indicator for indicating a geographic region to which a default access server belongs when it is detected that an intelligent device is accessing a network; determining the default access server according to the geographic region indicated by the first access indicator; and accessing the default access server by the intelligent device.

According to the embodiments of the present disclosure, the technical solution may have the following advantageous effects.

By obtaining the first access indicator for indicating the geographic region to which the default access server belongs, determining the default access server according to the geographic region indicated by the first access indicator, and accessing the default access server, the server in the corresponding geographic region is selected as the default access server when accessing the network, the present disclosure can guarantee a communication speech and control effects with the server, thus improving a user experience.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating an application scenario involved in a method for accessing a server according to some exemplary embodiments of the present disclosure.

FIG. 2 is a flow chart showing a method for accessing a server according to an exemplary embodiment.

FIG. 3 is a flow chart showing a method for accessing a server according to another exemplary embodiment.

FIG. 4 is a flow chart showing a method for accessing a server according to another exemplary embodiment.

FIG. 5 is a block diagram showing an apparatus for accessing a server according to an exemplary embodiment.

FIG. 6 is a block diagram showing an apparatus for accessing a server according to another exemplary embodiment.

FIG. 7 is a block diagram showing an apparatus according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

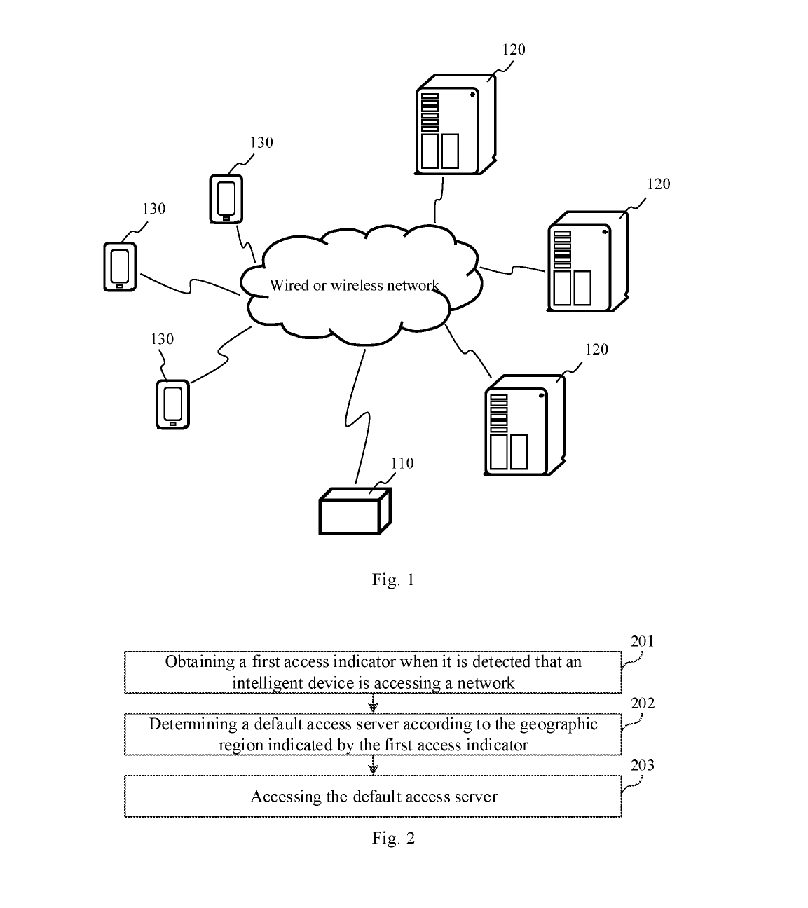

FIG. 1 is a schematic diagram illustrating an application scenario involved in a method for accessing a server according to some exemplary embodiments of the present disclosure. The application scenario includes an intelligent device 110 and at least one server 120.

The intelligent device 110 may be a smart home appliance, such as a smart television, an intelligent air conditioner, an intelligent router, a smart camera and an intelligent rice cooker.

The server 120 may be a server, a service cluster consisting of several servers, or a cloud computing service center.

The intelligent device 110 and the server 120 are connected via a wired or wireless network.

The application scenario further includes at least one control terminal 130. The control terminal 130 may be an intelligent mobile terminal, such as a smart phone, a tablet computer and an e-book reader. Alternatively, the control terminal 130 may be an intelligent wearable device, such as a smart watch or a pair of smart glasses. Further, the control terminal 130 may be a personal computer or a remote controller of the intelligent device 110.

The control terminal 130 and the server 120 are connected via a wired or wireless network. The control terminal 130 may obtain a working status of the intelligent device 110 via the server 120, or send a control instruction to the intelligent device 110 via the server 120.

FIG. 2 is a flow chart showing a method for accessing a server according to an exemplary embodiment. The method for accessing the server is implemented by the intelligent device 110 or the control terminal 130 in the application scenario as shown in FIG. 1. As shown in FIG. 2, the method for accessing the server may include the following steps.

In step 201, a first access indicator is obtained when it is detected that the intelligent device is accessing a network.

The first access indicator is used to indicate a geographic region to which a default access server accessed by the intelligent device belongs.

In step 202, the default access server is determined according to the geographic region indicated by the first access indicator.

In step 203, the default access server is accessed.

In conclusion, according to the embodiments of the present disclosure, the first access indicator for indicating the geographic region to which the default access server accessed by the intelligent device belongs is obtained, and the default access server accessed by the intelligent device is determined according to the first access indicator and the intelligent device is controlled to access the default access server. Accordingly, the server in the geographic region to which the intelligent device belongs is selected as the default access server of the intelligent device when the intelligent device accesses the network, so the present disclosure can guarantee the communication speech and the control effects between the intelligent device and the server, thus improving the user experience.

In the technical solution of the present disclosure, the first access indicator in the method shown in FIG. 1 may be used to indicate the geographic region of the control terminal corresponding to the intelligent device, or directly indicate the geographic region of the intelligent device. The following embodiments of the present disclosure will exemplify the two situations.

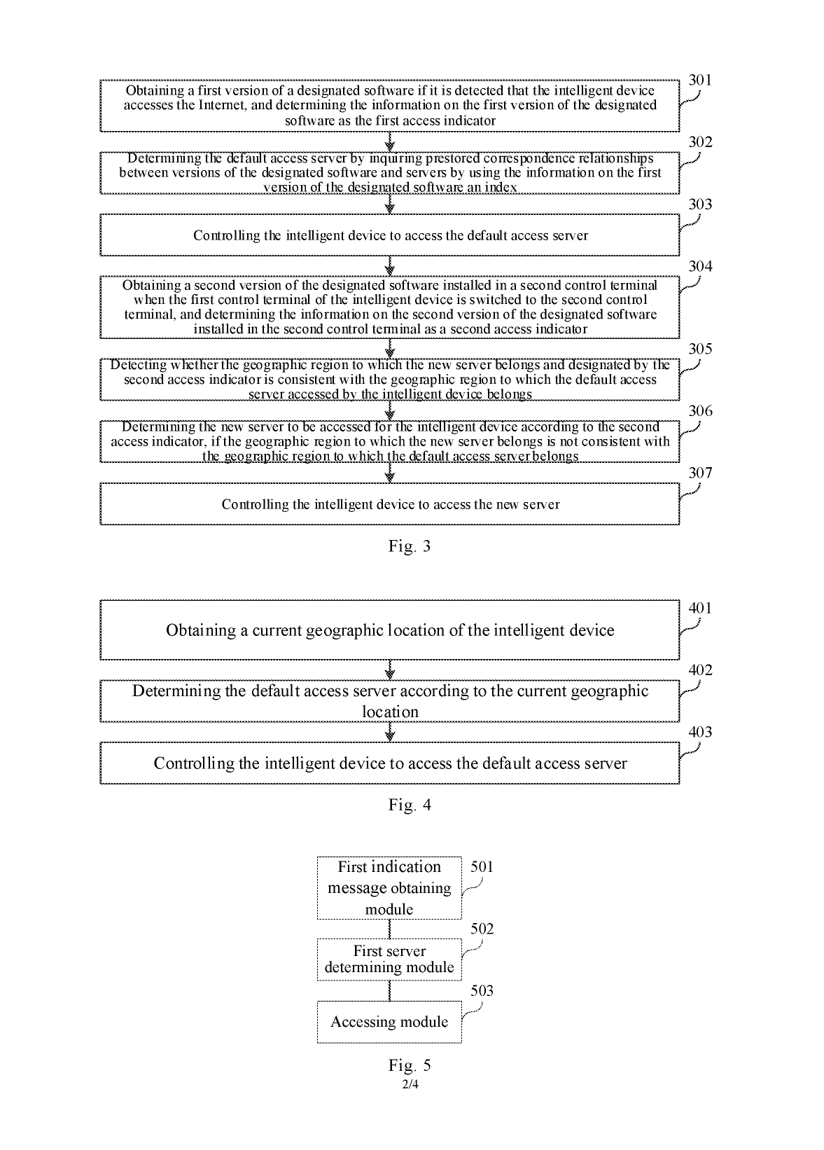

FIG. 3 is a flow chart showing a method for accessing a server according to another exemplary embodiment. The method for accessing the server is implemented by the intelligent device 110 or the control terminal 130 in the application scenario as shown in FIG. 1. As shown in FIG. 3, the method for accessing the server may include the following steps.

In step 301, information on a first version of a designated software is obtained if it is detected that the intelligent device accesses the network, and the information on the first version of the designated software is determined as the first access indicator.

The designated software is installed in a first control terminal of the intelligent device.

A management software for managing the intelligent device may be installed in the control terminal of the intelligent device, and the management software is the above designated software. With the increase of countries or regions for sale of the intelligent device, the manufactures may develop corresponding versions of the management software for different countries or regions, such that users in each country or region may download the corresponding version of the management software. When the control terminal installed with the management software is connected with the server, the control terminal may access the server corresponding to the country or region consistent with the version of the management software installed therein. For example, the users in China may download and install the management software in the Chinese version via the control terminal, and access the server in China when the control terminal is connected with the server. Alternatively, the user in America may download the management software in the American version via the control terminal, and access the server in America when the control terminal is connected with the server.

With the technical solution shown in the embodiment of the present disclosure, the software version of the management software installed in the control terminal of the intelligent device is used to indicate the geographic region to which the default access server accessed by the intelligent device belongs. For instance, when the management software is in the Chinese version, the geographic region to which the default access server accessed by the intelligent device belongs is the Chinese region. When the management software is in the American version, the geographic region to which the default access server accessed by the intelligent device is the American region.

In step 302, the default access server is determined by inquiring prestored correspondence relationships between versions of the designated software and servers by using the information on the first version of the designated software as an indext.

It is possible to search for the default access server according to the information on the first version of the designated software, when the default access server is determined according to the geographic region indicated by the first access indicator.

The intelligent device accesses the network and establishes connection with the server by a built-in communication module. With the technical solution shown in the embodiment of the present disclosure, the manufactures may develop a unified firmware for the communication module of the intelligent device for sale in all the countries or regions, and the firmware stores the correspondence relationship between each software version and each server. When the intelligent device accesses the network, it is possible to obtain the information on the version of the control software installed in the control terminal, to search for the server corresponding to the version of the control software installed in the control terminal according to the correspondence relationship stored in the firmware, and to determine the server as the default access server.

Alternatively, the correspondence relationship between each software version and each server may be stored in the control terminal. When the intelligent device is controlled to access network by the control terminal, the management software installed in the control terminal inquires the corresponding server according to its own software version, and sets the inquired server as the default access server accessed by the intelligent device.

In some embodiments, when the intelligent device has accessed the network, the control terminal of the intelligent device is detected. A request is sent to the control terminal, and a response message including the first access indicator is received from the control terminal in response to the request. Then the intelligent device searches for the servers which the intelligent device can access and accesses the server according to the first access indicator.

In some embodiments, when an intelligent device is started, the intelligent device will detect and access the network which could be a wired or wireless network. When the intelligent device has accessed the network, the intelligent device will connect to the control terminal of the intelligent device. In some embodiment, the control terminal could be in connection with the intelligent device via wired or wireless manner, such as Bluetooth, Wi-Fi, or infrared etc. When the intelligent device has detected the control terminal, a request will be sent to the control terminal. After the control terminal has received the request, the designated software that installed in the control terminal is detected. In some embodiments, the designated software could be a management software managing the intelligent device. After the control terminal has received the request, it performs the following: detecting the version number, language, communication list of the designated software; and generating a first access indicator that includes information on the geographic regions, which will be sent to the intelligent device. When the intelligent device has received the first access indicator that includes the information on geographic region, it performs the following: inquiring the server which the intelligent device can access; acquiring an address list of accessible servers; generating geographic region lists that corresponds to the servers according to the address list of the servers; matching the geographic regions of the first access indicator, if the geographic regions of the first access indicator match the geographic regions in the geographic region list that corresponds to the server. Then the intelligent device will access the server with address matching the first access indicator.

In some embodiments, when the intelligent device has received the first access indicator that includes information on the geographic regions, the intelligent device performs the following: inquiring the servers that the intelligent device can access, acquiring the address list of the accessible servers, and generating multiple geographic region lists that correspond to the servers according to the address list of the servers. In some embodiments, the accuracy of the multiple geographic region lists could be different, for example, three geographic region lists could be generated according to the address list of the server. In this case, a first geographic region list is generated in the municipal level, a second geographic region list is generated in the provincial level and a third geographic region is generated in the national level. The priority of the geographic regions could be set in accordance with the accuracy. For example, the lists with higher accuracy obtain higher priority, and the lists with lower accuracy obtain lower priority. In some embodiments, it's also possible that the lists with lower accuracy obtain higher priority, and the lists with lower accuracy obtain higher priority. In some embodiments, the geographic regions of the first access indicator could be matched in accordance with the order of the priority. For example, a step of matching the geographic regions of servers with higher priority, such as the geographic region list of municipal level, is conducted at first. If matched, the server with an address that matching the first access indicator is accessed. If not, a step of matching the geographic region list of lower priority, such as the geographic region list of provincial level is further conducted. If matched, the server with an address that matching the first access indicator is accessed. If not, a step of matching the geographic region list of still lower priority, such as the geographic region list of national level is further conducted, and the server with an address that matching the first access indicator is accessed.

In some embodiments, the geographic region lists that corresponding to the servers can include multiple geographic regions that correspond to the server addresses, where the administrative levels of the included multiple geographic regions are different to each other, such as, the server address of 202.102.192.68 could correspond to China, Anhui, Hefei; in some embodiments, matching the geographic regions of the first access indicator by matching from the lower administrative level to the higher one, and the server address which is matched can be regarded as the server address of default access.

In step 303, the intelligent device is controlled to access the default access server.

After the default access server is determined, the intelligent device may access the determined server under its own decision or under control of the control terminal.

In step 304, information on a second version of the designated software installed in a second control terminal is obtained when the first control terminal of the intelligent device is switched to the second control terminal, and the information on the second version of the designated software installed in the second control terminal is determined as a second access indicator.

In step 305, it is detected whether the geographic region to which the new server belongs and designated by the second access indicator is consistent with the geographic region to which the default access server accessed by the intelligent device belongs.

In step 306, the new server is determined according to the second access indicator, if the geographic region to which the new server belongs is not consistent with the geographic region to which the default access server belongs.

In step 307, the intelligent device is controlled to disconnect from the default access server and access the new server.

In practical applications, there may be more than one control terminals for an intelligent device. For example, the owner of the intelligent device may share the control authority thereof with other users who may realize control of the intelligent device by using their respective control terminals. If a device-sharing user is located in a region different from the geographic region to which the access server accessed by the intelligent device belongs, the access server accessed by the control terminal of the device-sharing user may not be the same the access server accessed by the intelligent device. In such a case, communication data between the control terminal and the intelligent device needs to be forwarded among multiple servers during the control of the intelligent device by the control terminal of the device-sharing user, which affects the control effect and user experience.

Consequently, in the technical solution shown in the embodiment of the present disclosure, when it is detected that the first control terminal of the intelligent device is switched into the second control terminal, the version of the management software installed in the second control terminal is obtained first, and it is detected whether the geographic region indicated by the version of the management software installed in the second control terminal is consistent with the geographic region to which the current access server accessed by the intelligent device. If yes, no further processing is conducted; and if not, it is necessary to inquire a new server according to the geographic region indicated by the second version of the management software installed in the second control terminal and to control the intelligent device to switch to the new server.

For example, a certain smart camera is sold in several countries or regions including China and America, and the manufacturer sets at least one server respectively for each selling country or region. For instance, Mr. Wang in China mounts the smart camera, downloads and installs a control software of the Chinese version in a smart phone A. When the smart phone A is used to control the smart camera to access the network, the smart camera obtains the version of the control software installed in the smart phone A and finds that the default access server is a server a in the Chinese region according to the software version in the smart phone A. Thus, the smart camera accesses the server a. If Mr. Wang purchases a smart camera produced and sold in China, and gives it to his friend Mike who lives in America. Mike downloads and installs a control software of the American version in a smart phone B after he mounts the smart camera in America. When Mike uses the smart phone B to control the smart camera to access the network, the smart camera obtains the version of the control software installed in the smart phone B and finds that the default access server is a server b in the American region according to the software version in the smart phone B. Hence, the smart camera accesses the inquired server b.

Later Mr. Wang wants to share the smart camera mounted in China with Mike, and hence sets the smart phone B as a control terminal for the smart camera mounted in China. When Mike uses the smart phone B to control the smart camera mounted by Mr. Wang, the smart phone B becomes the control terminal of the smart camera mounted by Mr. Wang. At the moment, the smart camera mounted by Mr. Wang first obtains the version of the control software installed in the smart phone B and detects that the version is not the Chinese version but the American version, so the smart camera mounted by Mr. Wang inquires and determines the server b in the American region as the server to be switched into according to the version of the control software installed in the smart phone B, and switches connection to the server b.

FIG. 4 is a flow chart showing a method for accessing a server according to another exemplary embodiment. The method for accessing the server is implemented by the intelligent device 110 or the control terminal 130 in the application scenario as shown in FIG. 1. As shown in FIG. 4, the method for accessing the server may include the following steps.

In step 401, a current geographic location of the intelligent device is obtained and information on the current geographic location is determined as the first access indicator.

In this embodiment of the present disclosure, the intelligent device or the control terminal of the intelligent device may directly obtain the geographic location of the intelligent device and take the geographic location as the first access indicator for selecting the default access server. In this cases, information on the geographic location may indicate the location of the intelligent device itself or the location of control terminal. The geographic location may be obtained by the following ways.

In some embodiments, the information on geographic locations can be obtained by a way of satellite positioning. The intelligent device or the control terminal thereof may preset a satellite positioning function, such that it is possible to determine the geographic coordinates of the intelligent device or those of the control terminal of the intelligent device by satellite positioning (e.g. GPS or BeiDou Navigation Satellite System).

Alternatively, the information on geographic locations can be obtained based on geographic attribution of user's mobile phone number or area code of landline phone number. The intelligent device or the control terminal thereof may be connected with the mobile phone of the user or the landline phone, and obtain the geographic attribution of the mobile phone number or the area code of the landline phone number, such that the geographic location is determined according to the geographic attribution of the mobile phone number or the area code of the landline phone number, in which it is possible to directly obtain the geographic attribution of the mobile phone number when the control terminal is the smart phone.

Alternatively, the information on geographic locations can be obtained by a way of Wi-Fi (wireless fidelity) hotspot positioning. Since a Wi-Fi hotspot (like a wireless router) covers a relatively small area and has a relatively fixed position, geographic locations of most Wi-Fi hotspots are recorded by the operator. The Wi-Fi hotspot may emit around a wireless signal upon being energized, and the wireless signal includes a unique ID of the Wi-Fi hotspot. When the intelligent device or the control terminal thereof has a built-in Wi-Fi function, the unique ID may be obtained as long as the wireless signal emitted by the Wi-Fi hotspot is received. The intelligent device or the control terminal thereof intercepts what Wi-Fi hotspots are nearby, checks the signal strength of each Wi-Fi hotspot, and sends the respective IDs and signal strength of these Wi-Fi hotspots to a designated server (like Skyhook server). The Skyhook server may inquire the coordinates of each hotspot recorded in the database according to the ID and the signal strength thereof, compute and determine the coordinates of the intelligent device or the control terminal of the intelligent device, and send the coordinates determined by computation to the intelligent device or the control terminal of the intelligent device.

Alternatively, the information on geographic locations can be obtained by a way of base station positioning. Similar to Wi-Fi hotspot positioning, if the intelligent device or the control terminal thereof has a 2G, 3G or 4G function, the intelligent device or the control terminal thereof may scan ID and signal strength of surrounding wireless base stations, and send the respective IDs and the signal strength of the surrounding wireless base stations to the server of the operator. The server of the operator computes the coordinates of the intelligent device or the control terminal of the intelligent device according to the ID and the signal strength of the wireless base station, and sends the determined coordinates to the intelligent device or the control terminal thereof.

Alternatively, the information on geographic locations can be obtained based on common online delivery address or last delivery address. Usually a delivery address needs to be set for online shopping. The intelligent device or the control terminal thereof may be connected with a home network, obtains the common delivery address set by the user or the last delivery address from an electronic device (such as a smart phone, a tablet computer or a personal computer) for online shopping, and determines the geographic location according to the delivery address. When the control terminal is the smart phone for online shopping, the smart phone may directly obtain the delivery address set by the user.

Alternatively, the information on geographic locations can be obtained by a way of IP positioning. When accessing the network, the intelligent device or the control terminal thereof usually obtains an IP address which is distributed according to different regions, and then may determine the geographic location according to the IP address of the access network.

Alternatively, the information on geographic locations can be obtained based on geographic locations and post codes input by users during registration. For example, if an intelligent device is mounted and registered in a server, it is possible to prompt the user to input the geographic location or the post code, such that the intelligent device or the control terminal thereof may inquire the corresponding geographic location according to the geographic location or the post code input by the user.

Moreover, the user may input the geographic location and the post code which are used to obtain the geographic location, during registration of other devices or accounts (like Mi Account).

Alternatively, the information on geographic locations can be obtained based on information on scenery, buildings or landmarks displayed in recent mobile photos. The intelligent device or the control terminal thereof may be connected with the smart phone via the home network, obtain the recent photos shot by the smart phone, and analyze the geographic location of the photos based on the scenery, buildings or landmarks in the photos. When the control terminal is the smart phone, it is possible to directly obtain the photos in the smart phone and analyze the geographic location.

In step 402, the default access server is inquired according to the current geographic location.

It is possible to inquire the default access server according to the geographic location during determination of the default access server according to the geographic region indicated by the first access indicator.

With the technical solution shown in the embodiment of the present disclosure, the manufactures may develop a unified firmware for the communication module of the intelligent device for sale in all the countries or regions, and the firmware stores the correspondence relationship between each country or region and each server. When the intelligent device accesses the network, it is possible to obtain the geographic location of the intelligent device, to inquire the country or region according to the geographic location, to inquire the corresponding server of the country or region according to the correspondence relationship stored in the firmware, and to determine the server as the default access server.

Alternatively, the correspondence relationship between each country or region and each server may be stored in the control terminal. When the intelligent device is controlled to access the network by the control terminal, the management software installed in the control terminal inquires the corresponding country or region according to the geographic location of the intelligent device, inquires the server corresponding to the country or region according to the correspondence relationship stored in the firmware, and sets the inquired server as the default access server accessed by the intelligent device.

In step 403, the intelligent device is controlled to access the default access server.

An apparatus embodiment of the present disclosure in the following may be used to execute the method embodiment of the present disclosure. As for undisclosed details of the apparatus embodiment of the present disclosure, reference may be made to the method embodiment of the present disclosure.

FIG. 5 is a block diagram showing an apparatus for accessing a server according to an exemplary embodiment. The apparatus for accessing the server may be used in the intelligent device 110 or the control terminal 130 in the application scenario as shown in FIG. 1 to execute all or part of the steps of the method shown in any one of FIG. 2 to FIG. 4. As shown in FIG. 5, the apparatus for accessing the server may include but not be limited to a first indication message obtaining module 501, a first server determining module 502 and an accessing module 503.

The first indication message obtaining module 501 is configured to obtain a first access indicator for indicating a geographic region to which a default access server belongs, when it is detected that the intelligent device is accessing a network.

The first server determining module 502 is configured to determine the default access server according to the geographic region indicated by the first access indicator obtained by the first indication message obtaining module 501.

The accessing module 503 is configured to access the default access server determined by the first server determining module 502.

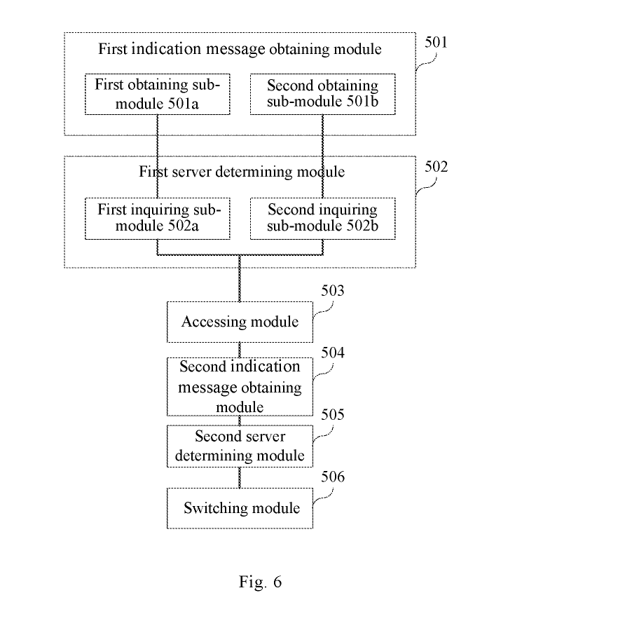

FIG. 6 is a block diagram of an apparatus for accessing a server according to another exemplary embodiment. The apparatus for accessing the server may be used in the intelligent device 110 or the control terminal 130 in the application scenario as shown in FIG. 1 to execute all or part of the steps of the method shown in any one of FIG. 2 to FIG. 4. As shown in FIG. 6, the apparatus may include but not be limited to a first indication message obtaining module 501, a first server determining module 502 and an accessing module 503.

The first indication message obtaining module 501 is configured to obtain a first access indicator for indicating a geographic region to which a default access server belongs, when it is detected that the intelligent device is accessing a network.

The first server determining module 502 is configured to determine the default access server according to the geographic region indicated by the first access indicator obtained by the first indication message obtaining module 501.

The accessing module 503 is configured to access the default access server determined by the first server determining module 502.

Alternatively, the first indication message obtaining module 501 includes a first obtaining sub-module 501a that is configured to obtain a first version of a designated software installed in a first control terminal and determine the first version of the designated software as the first access indicator.

The first server determining module 502 includes a first inquiring sub-module 502a that is configured to determine the default access server by inquiring prestored correspondence relationships between versions of the designated software and servers by using the information on the first version of the designated software obtained by the first obtaining sub-module 501a as an index.

Alternatively, the apparatus further includes: a second indication message obtaining module 504, a second server determining module 505 and a switching module 506.

The second indication message obtaining module 504 is configured to obtain a second version of the designated software installed in a second control terminal when the first control terminal is switched to the second control terminal after the accessing module 503 accesses the server, and to determine the second version of the designated software installed in the second control terminal as a second access indicator of the intelligent device.

The second server determining module 505 is configured to determine a new server to be accessed according to the second access indicator obtained by the second indication message obtaining module 504.

The switching module 506 is configured to switch access to the new server determined by the second server determining module 505.

Alternatively, the second server determining module 505 is configured to execute a step of determining the new server to be accessed according to the second access indicator, if the geographic region to which the new server belongs is not consistent with the geographic region to which the default access server belongs.

Alternatively, the first indication message obtaining module 501 includes a second obtaining sub-module 501b that is configured to obtain a current geographic location and to determine the current geographic location as the first access indicator.

The first server determining module 502 includes a second inquiring sub-module 502b that is configured to inquire the default access server according to the current geographic location obtained by the second obtaining sub-module 501b.

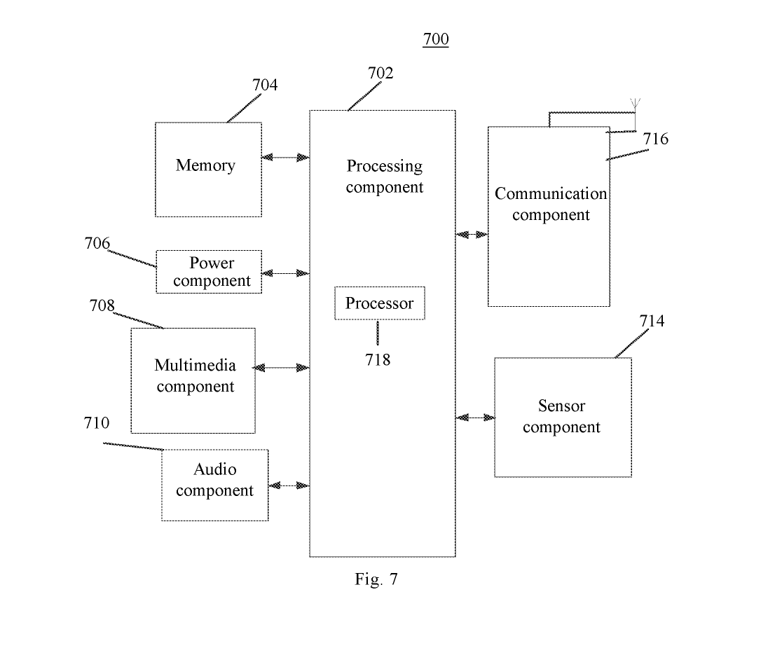

FIG. 7 is a block diagram showing an apparatus 700 according to an exemplary embodiment. For example, the apparatus 700 may be an intelligent device, such as a smart television, an intelligent air conditioner, an intelligent router, a smart camera and an intelligent rice cooker; or may be a control terminal of an intelligent device, such as a smart phone, a tablet computer, an e-book reader, a smart watch, a pair of smart glasses, a personal computer or a remote control.

Referring to FIG. 7, the apparatus 700 may include one or more of the following components: a processing component 702, a memory 704, a power component 706, a multimedia component 708, an audio component 710, a sensor component 714, and a communication component 716.

The processing component 702 typically controls overall operations of the device 700, such as the operations associated with display, telephone calls, data communications, camera operations, and recording operations. The processing component 702 may include one or more processors 718 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk. The memory 704 may further store one or more modules that are configured to be executed by the one or more processors 718 to perform all or part of the steps in the above method described in any one of FIG. 2 to FIG. 4.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action.

The audio component 710 is configured to output and/or input audio signals. For example, the audio component 710 includes a microphone (“MIC”) configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The sensor component 714 includes one or more sensors to provide status assessments of various aspects of the device 700. For instance, the sensor component 714 may detect an open/closed status of the device 700, relative positioning of components, a change in position of the device 700 or a component of the device 700, and a change in temperature of the device 700. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 2Q or 3Q or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 704, executable by the processor 710 in the apparatus 700, for performing the above-described methods. For example, the non-transitory computer-readable storage medium may be a ROM, a RAM, a CD-ROM, a magnetic tape, a floppy disc, an optical data storage device, and the like.

With respect to the apparatuses in the above embodiments, the specific manners for performing operations for individual modules therein have been described in detail in the embodiments regarding the methods for accessing a server, which will not be elaborated herein.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for accessing a server by an intelligent device, comprising:
obtaining a first access indicator for indicating a geographic region to which a default access server belongs, when it is detected that the intelligent device is accessing a network;
determining the default access server according to the geographic region indicated by the first access indicator; and
accessing, by the intelligent device, the default access server.

2. The method according to claim 1, wherein the intelligent device is connected to a first control terminal and the first access indicator includes information on a first version of a designated software, the first version of the designated software being installed in the first control terminal; and
wherein the default access server is determined by inquiring a database prestoring correspondence relationships between versions of the designated software and servers by using the information on the first version of the designated software as an index.

3. The method according to claim 2, further comprising:
after accessing the default access server, obtaining information on a second version of the designated software if it is detected that the intelligent device is switching connection with the first control terminal to the second control terminal, the second version of the designated software being installed in the second control terminal; and
determining the information on the second version of the designated software as a second access indicator.

4. The method according to claim 3, further comprising:
acquiring a geographic region to which a new server belongs according to the second access indicator;
determining whether the geographic region to which the new server belongs is consistent with the geographic region to which the default access server belongs; and
disconnecting from the default access server and accessing the new server, if the geographic region to which the new server belongs is not consistent with the geographic region to which the default access server belongs.

5. The method according to claim 1, wherein the first access indicator includes a current geographic location of the intelligent device; and wherein a server which provides network services covering the current geographic location of the intelligent device is determined as the default access server.

6. The method according to claim 1, wherein obtaining the first access indicator and determining the default access server are implemented by the intelligent device.

7. The method according to claim 6, wherein the intelligent device is connected to a first control terminal and obtains the first access indicator by sending a request to the first control terminal and receiving a response including the first access indicator from the first control terminal.

8. The method according to claim 2, wherein the designated software is installed in the first control terminal for enabling the first control terminal to manage the intelligent device.

9. A device for accessing a server, comprising:
a processor; and
a memory configured to store an instruction executable by the processor;
wherein the processor is configured to:
obtain a first access indicator for indicating a geographic region to which a default access server belongs, when it is detected that an intelligent device is accessing a network;
determine the default access server according to the geographic region indicated by the first access indicator; and
access, by the intelligent device, the default access server.

10. The device according to claim 9, wherein the intelligent device is connected to a first control terminal and the first access indicator includes information on a first version of a designated software, the first version of the designated software being installed in the first control terminal; and
wherein the default access server is determined by inquiring a database prestoring correspondence relationships between versions of the designated software and servers by using the information on the first version of the designated software as an index.

11. The device according to claim 10, wherein the processor is further configured to:
after accessing the default access server, obtain information on a second version of the designated software if it is detected that the intelligent device is switching connection with the first control terminal to the second control terminal, the second version of the designated software being installed in the second control terminal; and
determine the information on the second version of the designated software as a second access indicator.

12. The device according to claim 11, wherein the processor is further configured to:
acquire a geographic region to which a new server belongs according to the second access indicator;
determine whether the geographic region to which the new server belongs is consistent with the geographic region to which the default access server belongs; and
disconnect from the default access server and access the new server, if the geographic region to which the new server belongs is not consistent with the geographic region to which the default access server belongs.

13. The device according to claim 9, wherein the first access indicator includes a current geographic location of the intelligent device; and wherein a server which provides network services covering the current geographic location of the intelligent device is determined as the default access server.

14. The device according to claim 9, wherein the intelligent device is connected to a first control terminal and obtains the first access indicator by sending a requst to the first control terminal and receiving a response including the first access indicator from the first control terminal.

15. The device according to claim 10, wherein the designated software is installed in the first control terminal for enabling the first control terminal to manage the intelligent device.

16. A non-transitory computer-readable storage medium having stored therein instructions that, when executed by a processor of a device, causes the device to perform a method for accessing a server, the method comprising:
obtaining a first access indicator for indicating a geographic region to which a default access server belongs, when it is detected that an intelligent device is accessing a network;
determining the default access server according to the geographic region indicated by the first access indicator; and
accessing, by the intelligent device, the default access server.

17. The non-transitory computer-readable storage medium of claim 16, wherein the intelligent device is connected to a first control terminal and the first access indicator includes information on a first version of a designated software, the first version of the designated software being installed in the first control terminal; and
wherein the default access server is determined by inquiring a database prestoring correspondence relationships between versions of the designated software and servers by using the information on the first version of the designated software as an index.

18. The non-transitory computer-readable storage medium of claim 17, wherein the method further comprises:
after accessing the default access server, obtaining information on a second version of the designated software if it is detected that the intelligent device is switching connection with the first control terminal to the second control terminal, the second version of the designated software being installed in the second control terminal; and
determining the information on the second version of the designated software as a second access indicator.

19. The non-transitory computer-readable storage medium of claim 18, wherein the method further comprises:
acquiring a geographic region to which a new server belongs according to the second access indicator;
determining whether the geographic region to which the new server belongs is consistent with the geographic region to which the default access server belongs; and
disconnecting from the default access server and accessing the new server, if the geographic region to which the new server belongs is not consistent with the geographic region to which the default access server belongs.

20. The non-transitory computer-readable storage medium of claim 16, wherein the first access indicator includes a current geographic location of the intelligent device; and wherein a server which provides network services covering the current geographic location of the intelligent device is determined as the default access server.
